(19) United States
(12) Patent Application Publication
(10) Pub. No.: US 2006/0011399 A1
(43) Pub. Date: Jan. 19, 2006

(54) System and method for controlling vehicle operation based on a user's facial expressions and physical state

(75) Inventors: Brandon J. Brockway, Austin, TX (US); Tiffany Brooke Durham, Pflugerville, TX (US); Cheryl Louise Malatras, Cedar Park, TX (US); Gregory Wayne Roberts, Pflugerville, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/891,774

(22) Filed: Jul. 15, 2004

(51) Int. Cl. B60K 28/06

(52) U.S. Cl. 180/272

(57) ABSTRACT

A system and method for controlling vehicle operation based on a driver's facial expressions and physical state are provided. In particular, a system and method for differentiating between different types of emergency situations and applying an appropriate set of safety operations to ensure the safety of the driver, any other passengers, and others outside the vehicle are provided. With the system and method, facial expression recognition is used to distinguish between different types of emergency situations. For each of these emergency situations, a predetermined set of safety operations may be established. Once a particular emergency situation is detected based on the facial expression recognition, the corresponding set of safety operations are applied by sending appropriate control signals to vehicle control systems to cause the operation of the vehicle to be modified.

### BACKGROUND OF THE INVENTION

1. Technical Field

The present invention is directed to an improved computer control system for a vehicle. More specifically, the present invention is directed to a system and method for controlling vehicle operation based on a user's facial expressions and physical state.

2. Description of Related Art

Certain groups of people with physical and/or emotional disabilities are not permitted to operate vehicles due to an increased risk of these persons becoming unable to control the vehicle and risking injury to others. For example, people that have epilepsy may be refused a driver's license because of the risk that they may have a seizure during operation of the vehicle. People with epilepsy are considered among the largest groups of people that are unable to obtain driver's licenses and operate vehicles (2.5 million people with epilepsy are not permitted to obtain driver's license according to the epilepsy foundation). Therefore it would be desirable to provide safety mechanisms that would permit more persons with disabilities to legally operate vehicles while ensuring the safety of others.

Due to recent advances in facial expression recognition systems, there is a great opportunity available to incorporate these expression detection systems in vehicles to aid in determining the condition of drivers. Facial expression recognition is generally known in the art. Facial expression recognition involves using an image pickup device, such as a digital camera, to obtain images of a human being's face and then determine a change in emotional state based on changes in a persons facial features. Many systems have been devised that use various forms of facial expression recognition to perform different operations.

U.S. Pat. No. 6,293,361 issued to Mueller, which is hereby incorporated by reference, describes a system and process for braking a vehicle. The system senses changes of the bodily reactions of a driver that indicate an emergency situation or stress situation. As a function of sensors provided either on the user, on the steering wheel rim, or both, an automatic braking operation may be initiated. These sensors may detect a change in the blood pressure, the pulse, the pupil, facial expression, eyelid reflex, the muscle contraction, skin resistance and/or sweat secretion.

U.S. Patent Publication No. 2003/0117274 to Kuragaki et al., which is hereby incorporated by reference, describes an on-vehicle emergency communication apparatus for reporting an emergency situation with regard to a vehicle operator to emergency personnel. The system includes an emergency situation prediction unit for predicting the possibility of a vehicle encountering an emergency situation. As part of this prediction unit, an expression feature amount measuring unit is provided for measuring a drivers expression features and providing a signal to the emergency prediction unit.

U.S. Pat. No. 5,786,76 issued to Kumakara et al., which is hereby incorporated by reference, describes a system for estimating the drowsiness level of a vehicle driver based on the driver's blinking frequency. With this system a frequency distribution of blink duration of the driver is generated for a first predetermined period of time after start of a driving operation and a threshold is set for discrimination of slow blinks. The system then calculates, every second predetermined period, a ratio of the number of slow blinks to the total number of blinks of the driver's eyes during the second period. In this way, the system discriminates a rise in the drowsiness level of the driver in accordance with the calculated ratio.

Each of these systems is directed to using a limited facial expression recognition mechanism for discerning between two situations, i.e. normal situations and a potential emergency situation. There is no ability in any of these systems to differentiate between different types of emergency situations so that different types of action may be performed that are most suitable to the particular type of emergency situation. Therefore, it would be beneficial to have a system and method that permits differentiation between different emergency situations so that appropriate action may be taken for the particular emergency situation.

### SUMMARY OF THE INVENTION

The present invention provides a system and method for controlling vehicle operation based on a driver's facial expressions and physical state. In particular, the present invention provides a system and method for differentiating between different types of emergency situations and applying an appropriate set of safety operations to ensure the safety of the driver, any other passengers, and others outside the vehicle.

With the system and method of the present invention, facial expression recognition is used to distinguish between different types of emergency situations. For example, the facial expression recognition mechanism of the present invention is trained to differentiate between a facial expression that is indicative of a seizure, a stroke, falling asleep, a heart attack, and the like. For each of these emergency situations, a predetermined set of safety operations may be established.

The system, once it detects a particular emergency situation based on the facial expression recognition, applies the corresponding set of safety operations. The application of the set of safety operations includes sending appropriate control signals to vehicle control systems to cause the operation of the vehicle to be automatically modified to increase the safety of the occupants of the vehicle and those persons that may be in the vicinity of the vehicle. For example, appropriate signals may be generated for automatically steering the vehicle, braking the vehicle, reducing the speed of the vehicle, turning on the emergency flashers of the vehicle, and the like.

In addition the safety operations may include operations for attempting to bring the driver out of his current state and back into a state where the driver can safely operate the vehicle. For example, the safety operations may include sounding the vehicle's horn, turning on the interior lights of the vehicle, turning on and/or increasing the volume of the radio, turning on the heated seats, moving the seat back and forth, and the like.

The particular set of safety operations that are to be applied are predetermined and stored in memory. Preferably, the safety operations are those that have been determined through testing to be the types of operations that are most effective in changing the state of the driver from a potentially hazardous state to a normal state in which the driver has the ability to safely operate the vehicle. With such safety mechanisms in place, it is more likely that regulatory agencies will permit persons with particular physical and/or emotional disabilities to operate vehicles since the safety of the individuals and the public is ensured by the operation of the present system and method.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a portion of vehicle and the primary operational elements of a safety system in accordance with aspects of the present invention;

FIG. 2 is an exemplary block diagram illustrating the interaction of primary operational elements of one exemplary embodiment of the present invention;

FIG. 3 is an exemplary diagram illustrating the emergency situation notification aspect of one exemplary embodiment of the present invention;

FIG. 4 is an exemplary diagram illustrating various sets of safety operations that are to be applied to various emergency situations determined based on facial expression recognition in accordance with one exemplary embodiment of the present invention;

FIG. 5 is a flowchart outlining an exemplary operation of one exemplary embodiment of the present invention when detecting an emergency situation and applying an appropriate set of safety operations based on the detected emergency situation.

### DETAILED DESCRIPTION OF THE PREFERRED EMBODIMENT

The present invention is directed to an improved safety system and method for vehicles in which an operator's/driver's facial expressions are analyzed by a facial expression recognition engine and are used to determine if an emergency situation is present and, if so, the particular type of emergency situation that is present. A particular set of safety operations, which may be a subset of a plurality of possible safety operations, are then applied that correspond to the particular emergency situation determined using the facial expression recognition.

The present invention will be described in terms of the operation of an automobile, however the present invention is not limited to such. Rather, as will be apparent to those of ordinary skill in the art in view of the present description, the present invention may be applied to other types of vehicles including other types of land vehicles, water vehicles, and air vehicles. For example, the present invention may be used to provide a proper safety system for trucks, trains, buses, aircraft, boats, and the like.

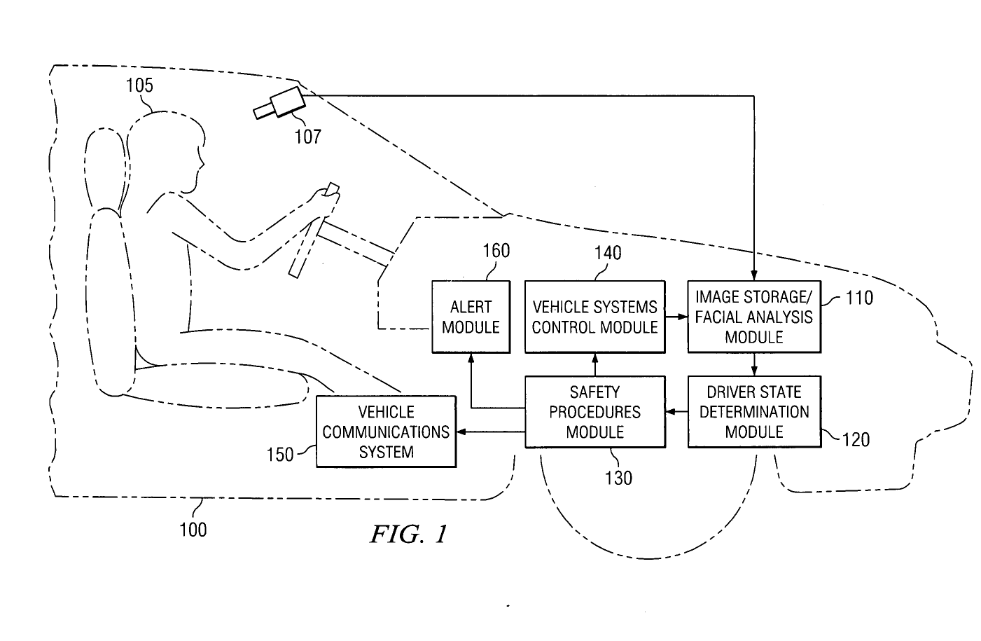

FIG. 1 is an exemplary diagram of a portion of vehicle and the primary operational elements of a safety system in accordance with aspects of the present invention. As shown in FIG. 1, images of the driver 105 are obtained using the image pickup device 107 which is mounted at a suitable location within the interior of the vehicle 100 such that high quality images of the driver's face are obtainable without interfering with the driver's view out of the vehicle. Some exemplary suitable locations for the image pickup device 107 may be on a visor, on a rear-view mirror, on the dashboard, integrated into the steering wheel, and the like. The image pickup device 107, in a preferred embodiment, is a digital camera of sufficiently small size that it will not create a diversion for the driver's eyes and will not block his/her view out the windshield or side windows of the vehicle 100.

The image pickup device 107 is used to obtain images of the driver 105 when the driver 105 is operating the vehicle in a normal manner. This may be, for example, shortly after turning on the ignition of the vehicle or otherwise starting operation of the vehicle. These images will serve as a baseline for determining differences in the driver's facial features that may be indicative of an emergency situation. These images, along with all subsequent images captured during the operation of the system, are provided to the image storage/facial analysis module 110.

The image storage/facial analysis module 110 stores the baseline images of the driver 105 obtained shortly after operation of the vehicle begins. The image storage/facial analysis module 110 also temporarily stores subsequent images obtained in order that they may be compared against the baseline images to determined differences in the driver's facial features. These differences are used to determine the driver's emotional state and whether that emotional state is indicative of a particular emergency situation.

The image storage/facial analysis module 110 determines differences between elements of baseline images of the driver 105 and subsequent images of the driver 105 taken by the image pickup device 107. These elements may be, for example, position of the driver's eyelids (open/closed), position of the driver's eyebrows, changes in the position of mouth features, creases in the driver's forehead indicative of pain, and a plethora of other possible elements that may be indicative of the driver's emotional state. The particular types of elements analyzed by the image storage/facial analysis module 110 are dependent upon the type of facial expression recognition employed in the particular embodiment.

The present invention may make use of any type of known or later developed facial expression recognition mechanism that may discern between various emotional states. In particular, the facial expression recognition mechanism of the present invention measures elements of a driver's face that have been determined to be indicative of distressful or emergency situations and may be used to distinguish between different types of distressful or emergency situations.

The differences between the baseline images and the subsequently captured images are provided to the driver state determination module 120. The driver state determination module 120 provides a intelligent determination engine that has been trained to recognize different types of distressful or emergency situations. For example, the driver state determination module 120 may be a neural network, expert system, inference engine, or the like, that takes the facial element difference information generated by the image storage/facial analysis module as input and operates on this input to determine a driver state that is most probable to be the driver's actual state.

As stated above, the driver state determination module 120 is preferably a trained intelligent system. The training of this system may include providing testing data of a driver's facial element differences in which the driver's emotional state is already known, determining the output generated by the driver state determination module 120, and then adjusting the weights, rules, etc., used to determine the output of the driver state determination module 120 so that the correct output is generated. Once trained, the driver state determination module 120 may be provided with actual facial element difference data and may be used to distinguish between emergency situations of a driver's state.

The driver state determination module 120 determines the state of the driver and provides this state information to the safety procedures module 130 if the state of the driver is one that is indicative of an emergency situation. For example, an initial determination may be made by the driver state determination module 120 as to whether the driver's state is one in which the driver is still coherent. If so, then no safety procedures need to be initiated. If the driver's state is one in which the driver is incoherent, such as with a seizure, being asleep, having a stroke, etc., then the driver state determination module 120 may perform further processing on the difference data provided by the image storage/facial analysis module 110 to determine the particular incoherent or emergency state that the driver is in.

Based on the determination that the driver is in an incoherent or emergency state, and the determination as to the particular emergency state the driver is in, the safety procedures module 130 determines an appropriate set of safety operations to perform on the vehicle 100 in order to ensure the safety of the driver 105, any passengers in the vehicle, and those in the vicinity of the vehicle 100. In a preferred embodiment, the set of safety operations that is performed is a subset of a master set of safety operations that may be used for a plurality of different emergency situations. For example, the safety operations that may be used in emergency situations may include, for example, slowing the vehicle to a predetermined safe speed, turning on hazard warning lights, honking a horn, turning on a radio, turning up the volume on the radio, moving the driver's seat, calling 911, etc. For a particular emergency situation, such as an epileptic seizure, the particular subset of safety operations that are performed may include slowing the vehicle to a safe speed, turning on the hazard warning lights, and honking the vehicles horn. Similarly, for a driver that is determined to have fallen asleep, the safety operations may be to slow to a safe speed, turn on the radio, turn up the radio volume, honk the horn, and move the driver's seat. Thus, each individual emergency situation may have its own corresponding set of safety operations that have been determined to be most appropriate to returning the driver from an incoherent state to a coherent state for that emergency situation.

The safety procedures module 130 issues instructions to other modules within the vehicle 100 to cause these safety operations to be performed by the vehicle 100. For example, the safety procedures module 130 may transmit control instructions to a vehicle systems control module 140 in the vehicle 100 to cause the vehicle to slow its speed, turn on hazard warning lights, turn on the radio/stereo, turn up the volume of the radio/stereo, honk the horn, move the driver's seat, etc.

In addition, the safety procedures module 130 may send instructions to an alert module 160 which may output an alert in order to gain the driver's attention and bring the driver back to a coherent state. For example, the alert module 160 may include an indicator light or an audio output device through which an audible sound or prerecorded message may be output so that the driver is more likely to return to a coherent state.

Also, the safety procedures module 130 may send instructions to the vehicle communication system 150 in order to communicate with appropriate emergency personnel to inform them of the emergency situation. For example, the vehicle communication system 150 may include a wireless communication device, such as a cellular or satellite telephone system, through which a prerecorded message may be sent to a remotely located emergency response office, e.g., a 911 dispatcher, fire station, police station, hospital, or the like. In addition, the vehicle communication system 150 may be used to contact predefined individuals, such as relatives, in the event of an emergency. If the vehicle 100 is equipped with a global positioning system or other type of location system, the precise location of the vehicle may also be communicated so that emergency personnel may be dispatched if needed.

As discussed above, the present invention provides a mechanism for determining a particular type of emergency situation that is generated due to a particular type of driver state. Thus, the present invention is able to discern between the driver experiencing a seizure, a stroke, a heart attack, the driver being asleep, etc. A particular set of safety operations is then initiated that are specific to that type of emergency situation.

While the set of safety operations indicates what safety operations to be performed, it also may indicate the order and timing of the safety operations. For example, a particular order of safety operations may be performed with a check between safety operations being performed to determine if the driver has returned to a coherent state. Thus, for example, if the driver is experiencing an epileptic seizure, the set of safety operations may designate that a first safety operation is to being slowing the vehicle to a predetermined safe speed. While this operation is being performed, a second safety operation of turning on the hazard warning lights may be performed in order to warn other drivers of the situation. Thereafter, if the driver has not returned to a coherent state, the present invention may cause the vehicle to honk the horn repeatedly. If the driver is still not coherent, the radio may be turned on and the volume increased. Thereafter, emergency personnel may be notified of the situation and a request for emergency assistance may be made using the vehicle's communication system.

The above description of the present invention assumes that the determination of driver state and the particular emergency situation that the driver is in, is based upon facial expression recognition. However, in other embodiments of the present invention, the driver state and emergency situation determination may be based on both facial expression recognition and the measurement of other driver and/or vehicle parameters. For example, data may be obtained from systems within the vehicle to determine whether the driver's operation of the vehicle is consistent with the emergency situation detected by facial expression recognition. Alternatively, the information from the other vehicle systems may be a trigger for performing the facial expression recognition. Thus, for example, a determination that the driver has failed to make slight movement of the steering wheel within a particular period of time, has failed to adjust the position of the gas or brake pedal within a predetermined period of time and the cruise control is not on, the driver's pulse is below or above normal as determined from a steering wheel mounted pulse monitor, or other measured parameter, may be used to either aid in or initiate the determination of the driver's state and the emergency situation based on facial expression recognition.

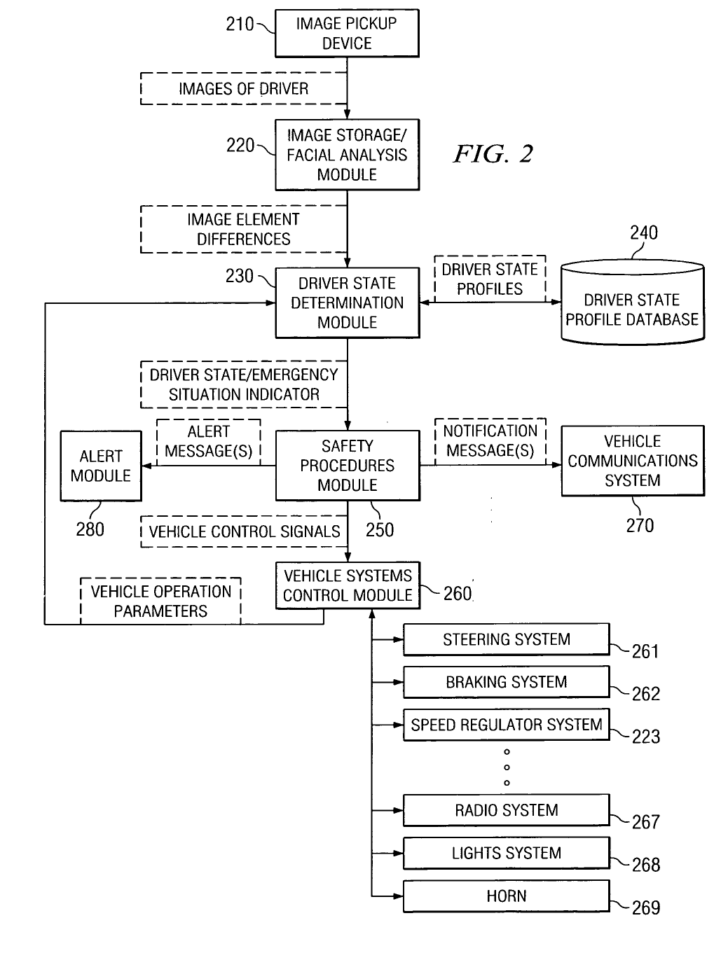

FIG. 2 is an exemplary block diagram illustrating the interaction of primary operational elements of one exemplary embodiment of the present invention. As shown in FIG. 2, the image pickup device 210 sends images of the driver to the image storage/facial analysis module 220. The image storage/facial analysis module stores and analyzes these images to determine image element differences which are then forwarded to the driver state determination module 230.

The driver state determination module 230, based on the image element differences, and optionally based on vehicle operation parameters obtained from the vehicle systems control module 260, matches this information to driver state profiles in the driver state profile database 240. In this way, the driver state determination module 230 determines a state of the driver and/or the particular emergency situation that needs to be corrected. An identifier of the driver state/emergency situation is sent to the safety procedures module 250 which determines a subset of the possible safety operations that is to be used for handling the identified driver state/emergency situation. The safety procedures module 250 may then send vehicle control signals to the vehicle systems control module 260, notification message(s) to the vehicle communications system 270 and alert message(s) to the alert module 280 in accordance with the selected subset of safety operations and the order of these safety operations.

The vehicle systems control module 260 may, in turn, send signals to one or more vehicle systems 261-269 to cause the subset of safety operations to be performed by the vehicle. For example, steering system 261 may be controlled to steer the vehicle to a shoulder of the roadway, braking system 262 may be used to reduce the speed of the vehicle, speed regulator system 263 may be used to maintain the vehicle at a safe speed, radio system 267 may be used to turn on the radio and/or increase the volume of the radio, lights system 268 may be used to turn on hazard warning lights, turn on interior lights of the vehicle, or the like, and horn 269 may be used to sound the vehicle's horn.

The vehicle communication system 270 may send prerecorded emergency warning messages and/or vehicle location information to remote emergency personnel. Alert module 280 may be used to generate alert messages within the vehicle's compartment so as to attempt to bring the driver back to a coherent state.

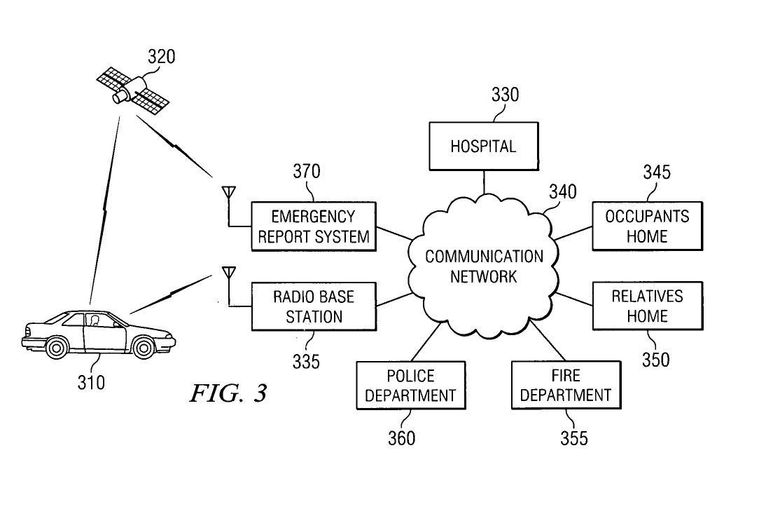

FIG. 3 is an exemplary diagram illustrating the emergency situation notification aspect of one exemplary embodiment of the present invention. As discussed above, part of the safety operations that may be performed within a subset of safety operations determined for a particular identified emergency situation, is the ability to notify remotely located emergency personnel and/or relatives of the emergency situation and the need for assistance. As shown in FIG. 3, this may be performed using wireless communication between the vehicle 310 and a communication network 340. The vehicle 310 may communicate with the communication network 340 via a wireless telephone system and radio base station 335, a satellite based communication system 320, or the like.

Messages sent by the vehicle 310 are received either by the satellite communication system 320 and wirelessly forwarded to the emergency report system 370 or are received by the radio base station 335 and transmitted to the emergency report system 370 via the network 340. The messages may include an identifier of the vehicle 310, a location of the vehicle, and one or more messages indicating the particular emergency state and any prerecorded or predefined messages requesting assistance.

The emergency report system 370 may store information regarding the personnel to be contacted in response to an emergency assistance request from the vehicle 310 as well as particular information about the driver (age, gender, weight, height, etc.) and the vehicle (make, model, license plate number, etc.) that may be of use to emergency personnel. This information may indicate particular relatives to be contacted, doctors, etc., and their contact information. In addition, the emergency report system 370 may maintain contact information for emergency personnel for a variety of locations.

Based on the location information forwarded by the vehicle 310, the emergency report system 370 may determine the closest emergency personnel to the vehicle's location and may send messages to the emergency personnel requesting assistance and indicating the vehicle's information, location information, and the emergency situation. For example, the emergency report system 370 may send emergency requests to the fire department 355, the police department 360, and a nearby hospital 330 indicating the particular emergency situation, the location of the vehicle, the driver and vehicle information, and requesting assistance. In addition, the emergency report system 370 may notify a relative at their home 350 or at the driver's home 345 of the situation. In this way, various sources of aid are notified of the situation so that appropriate help may be obtained by the driver.

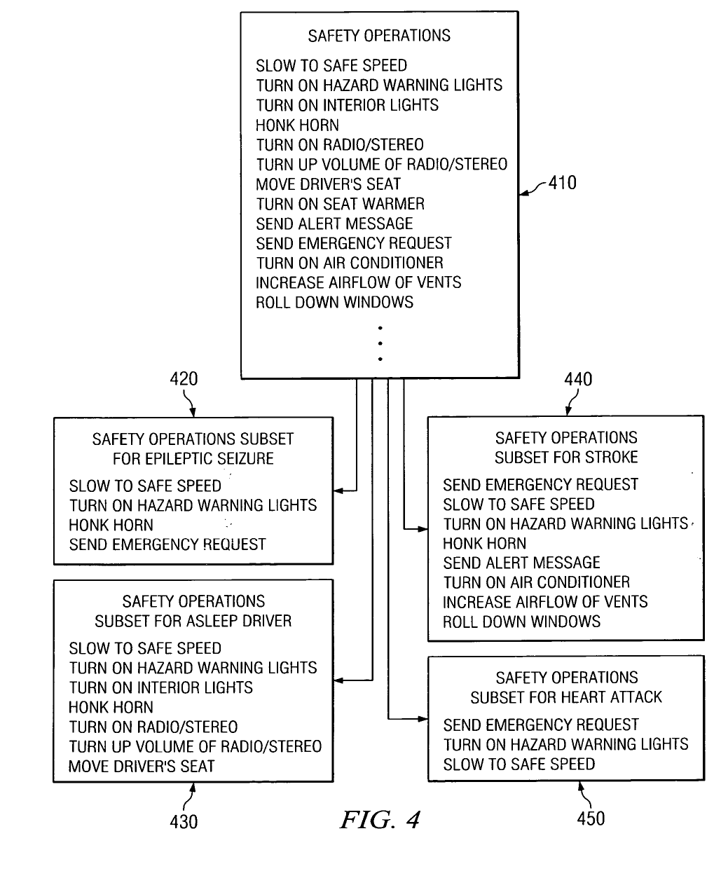

FIG. 4 is an exemplary diagram illustrating various sets of safety operations that are to be applied to various emergency situations determined based on facial expression recognition in accordance with one exemplary embodiment of the present invention. As discussed previously, there may be a plurality of different safety operations that may be performed in various emergency situations. The particular ones that are performed and the order in which they are performed may be different for each emergency situation. This is illustrated in FIG. 4.

As shown in FIG. 4, a set of possible safety operations 410 that may be performed in emergency situations is designated along with the appropriate control signals, parameters, etc., that are needed to perform these safety operations. Particular ones of these safety operations are combined to form subsets 420-450 of safety operations for various emergency situations and driver states. In addition, each subset 420-450 may have a different ordering of these safety operations based on the particular order that best alleviates the emergency situation and brings the driver back to a coherent state.

For example, subset 420 corresponds to a driver state/emergency situation in which the driver is having an epileptic seizure and thus, the driver is incoherent. The safety operations may include slowing the vehicle to a safe speed, turning on the hazard warning lights, honking the vehicle horn, and sending an emergency assistance request to remotely located emergency personnel. These safety operations may be initiated in the order listed with checks between one or more operations to determine if the driver has returned to a coherent state. The slowing of the vehicle is to lessen the probability of an accident causing severe injury. The turning on of the hazard warning lights is to inform other drivers that there is something wrong with the vehicle and to use caution when approaching the vehicle. Honking the horn is an attempt to get the driver to come out of the seizure. Sending the emergency request is an attempt to have emergency personnel dispatched to the vehicle's location so that medical aid may be provided to the driver.

The other subsets 430-450 are established for other types of driver states/emergency situations and may have different sets of safety operations and ordering of safety operations associated with them. Preferably, the set of safety operations for a particular driver state/emergency situation are determined based on the safety operations that will most likely bring the driver back to a coherent state from the particular driver state/emergency situation, increase the safety of the driver while in an incoherent state, and provide necessary emergency assistance if the driver is not able to be returned to a coherent state.

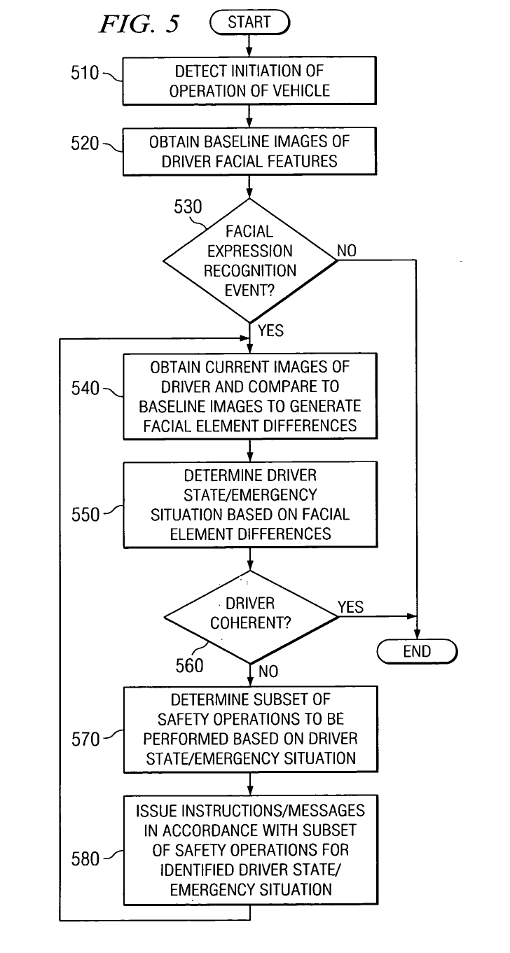

FIG. 5 is a flowchart outlining an exemplary operation of one exemplary embodiment of the present invention when detecting an emergency situation and applying an appropriate set of safety operations based on the detected emergency situation. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 5, the operation starts by detecting the initiation of operation of the vehicle by a driver (step 510). Baseline images of the driver facial features are then obtained using an image pickup device (step 520). A determination is then made as to whether a facial expression recognition event has occurred (step 530). This may be, for example, the detection of a driver parameter or vehicle operation parameter that is indicative of a potential problem with the driver or vehicle, may be simply a predetermined elapsed period of time since a last facial expression recognition event occurred, or the like.

If a facial expression recognition event has not occurred, then the operation terminates. If a facial expression recognition event has occurred, then current images of the driver are obtained and compared to the baseline images to generate facial element differences (step 540). A driver state/emergency situation is determined based on the facial element differences (step 550) and a determination is made as to whether the driver is in a coherent state (step 560).

If the driver is in a coherent state, the operation terminates. Otherwise, if the driver is not in a coherent state, a subset of safety operations to be performed is determined based on the identified driver state/emergency situation (step 570). Instructions and/or messages are then issued in accordance with the subset of safety operations for the identified driver state/emergency situation (step 580).

The operation then returns to step 540 where the operations are repeated to determine if the driver has returned to a coherent state. If not, the safety operations may be repeated until the driver is once again in a coherent state or the operation of the vehicle by the driver is discontinued. The operation then ends.

Thus, the present invention provides a mechanism for distinguishing between various types of driver incoherent states/emergency situations and applying different sets of safety operations based on the particular driver state/emergency situation identified. In this way, the likelihood that the driver is returned to a coherent state prior to an accident is increased. In addition, the safety of the vehicle occupants and those in the vicinity of the vehicle is increased. Moreover, the present invention provides a mechanism for contacting emergency personnel so that the driver may receive the emergency aid that he/she needs based on the identified driver state/emergency situation.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of automatically controlling an operation of a vehicle, comprising:
receiving facial expression input from an image pickup device, wherein the facial expression input includes images of an operator of the vehicle;
performing facial expression recognition on the facial expression input to identify a particular type of emergency situation from a plurality of possible emergency situations; and
automatically applying a subset of safety operations, from a plurality of safety operations, to a vehicle control module, corresponding to the particular type of emergency situation identified by the facial expression recognition, to thereby control the operation of the vehicle.

2. The method of claim 1, wherein performing facial expression recognition on the facial expression input includes:
obtaining at least one baseline image of the operator;
comparing the facial expression input to the at least one baseline image of the operator;
determining differences between the facial expression input and the at least one baseline image of the operator; and
comparing the differences to operator state profiles to determine a state of the operator and an emergency situation of the vehicle.

3. The method of claim 2, wherein the baseline image is obtained in response to detection of ignition of the vehicle.

4. The method of claim 1, wherein performing facial expression recognition on the facial expression input to identify a particular type of emergency situation from a plurality of possible emergency situations, includes:
determining if the operator is in an incoherent state; and
determining a particular incoherent state of the operator based on differences between the operator's facial features in the facial expression input and at least one baseline image of the operator, if the operator is determined to be in an incoherent state.

5. The method of claim 1, wherein the plurality of safety operations include at least one operation for automatically notifying persons exterior to the vehicle, yet in the vicinity of the vehicle, of the emergency situation.

6. The method of claim 1, wherein the plurality of safety operations include at least one operation for automatically attempting to bring the operator out of an incoherent state.

7. The method of claim 1, wherein the plurality of safety operations include at least one operation for automatically notifying remotely located emergency response personnel of the emergency situation.

8. The method of claim 7, wherein the at least one operation for automatically notifying remotely located emergency response personnel of the emergency situation further includes at least one operation for automatically notifying the remotely located emergency response personnel of a location of the vehicle.

9. The method of claim 1, wherein the plurality of safety operations include at least one of automatically steering the vehicle, automatically braking the vehicle, reducing a speed of the vehicle, turning on emergency warning lights on the vehicle, honking a horn on the vehicle, turning on a radio in the vehicle, increasing a volume of the radio in the vehicle, initiating a call to an emergency response service, moving an operator's seat in the vehicle,

10. The method of claim 1, wherein the plurality of emergency situations includes at least one of an operator having a stroke, an operator having a seizure, and operator having a heart attack, and an operator having fallen asleep.

11. The method of claim 1, wherein the subset of safety operations for the particular emergency situation identifies an order in which the safety operations within the subset of safety operations are to be performed, and wherein the safety operations, in the subset of safety operations, are applied to the vehicle control module in the order specified by the subset of safety operations.

12. The method of claim 1, wherein the subset of safety operations for the particular emergency situation identifies timing information for timing when the safety operations within the subset of safety operations are to be performed, and wherein the safety operations within the subset of safety operations are applied to the vehicle control module in accordance with the timing information.

13. The method of claim 1, wherein the receiving, performing and automatically applying steps are performed in response to at least one of a measurement of a vehicle operational parameter and a measured operator parameter indicating a need to determine if an emergency situation is present or imminent.

14. A system for automatically controlling an operation of a vehicle, comprising:
means for receiving facial expression input from an image pickup device, wherein the facial expression input includes images of an operator of the vehicle;
means for performing facial expression recognition on the facial expression input to identify a particular type of emergency situation from a plurality of possible emergency situations; and
means for automatically applying a subset of safety operations, from a plurality of safety operations, to a vehicle control module, corresponding to the particular type of emergency situation identified by the facial expression recognition, to thereby control the operation of the vehicle.

15. The system of claim 14, wherein the means for performing facial expression recognition on the facial expression input includes:
means for obtaining at least one baseline image of the operator;
means for comparing the facial expression input to the at least one baseline image of the operator;
means for determining differences between the facial expression input and the at least one baseline image of the operator; and
means for comparing the differences to operator state profiles to determine a state of the operator and an emergency situation of the vehicle.

16. The system of claim 15, wherein the baseline image is obtained in response to detection of ignition of the vehicle.

17. The system of claim 14, wherein the means for performing facial expression recognition on the facial expression input to identify a particular type of emergency situation from a plurality of possible emergency situations, includes:
means for determining if the operator is in an incoherent state; and
means for determining a particular incoherent state of the operator based on differences between the operator's facial features in the facial expression input and at least one baseline image of the operator, if the operator is determined to be in an incoherent state.

18. The system of claim 14, wherein the plurality of safety operations include at least one operation for automatically notifying persons exterior to the vehicle, yet in the vicinity of the vehicle, of the emergency situation.

19. The system of claim 14, wherein the plurality of safety operations include at least one operation for automatically attempting to bring the operator out of an incoherent state.

20. The system of claim 14, wherein the plurality of safety operations include at least one operation for automatically notifying remotely located emergency response personnel of the emergency situation.

21. The system of claim 20, wherein the at least one operation for automatically notifying remotely located emergency response personnel of the emergency situation further includes at least one operation for automatically notifying the remotely located emergency response personnel of a location of the vehicle.

22. The system of claim 14, wherein the plurality of safety operations include at least one of automatically steering the vehicle, automatically braking the vehicle, reducing a speed of the vehicle, turning on emergency warning lights on the vehicle, honking a horn on the vehicle, turning on a radio in the vehicle, increasing a volume of the radio in the vehicle, initiating a call to an emergency response service, moving an operator's seat in the vehicle,

23. The system of claim 14, wherein the plurality of emergency situations includes at least one of an operator having a stroke, an operator having a seizure, and operator having a heart attack, and an operator having fallen asleep.

24. The system of claim 14, wherein the subset of safety operations for the particular emergency situation identifies an order in which the safety operations within the subset of safety operations are to be performed, and wherein the means for applying the subset of safety operations applies the safety operations to the vehicle control module in the order specified by the subset of safety operations.

25. The system of claim 14, wherein the subset of safety operations for the particular emergency situation identifies timing information for timing when the safety operations within the subset of safety operations are to be performed, and wherein the means for applying the subset of safety operations applies safety operations within the subset of safety operations to the vehicle control module in accordance with the timing information.

26. The method of claim 1, wherein the means for receiving, means for performing and means for automatically applying operate in response to at least one of a measurement of a vehicle operational parameter and a measured operator parameter indicating a need to determine if an emergency situation is present or imminent.

27. A computer program product in a computer readable medium for automatically controlling an operation of a vehicle, comprising:
first instructions for receiving facial expression input from an image pickup device, wherein the facial expression input includes images of an operator of the vehicle;
second instructions for performing facial expression recognition on the facial expression input to identify a particular type of emergency situation from a plurality of possible emergency situations; and
third instructions for automatically applying a subset of safety operations, from a plurality of safety operations, to a vehicle control module, corresponding to the particular type of emergency situation identified by the facial expression recognition, to thereby control the operation of the vehicle.
